(19) United States
(12) Patent Application Publication
(10) Pub. No.: US 2004/0158862 A1
(43) Pub. Date: Aug. 12, 2004

(54) Apparatus for and method of searching multimedia contents on television

(75) Inventors: Kyung-chul Nam, Seoul (KR); Eun-kyung Kang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/768,658

(22) Filed: Feb. 2, 2004

(30) Foreign Application Priority Data
Feb. 3, 2003 (KR) 2003-6536

(51) Int. Cl. H04N 5/445; G06F 13/00; G06F 3/00

(52) U.S. Cl. 725/52; 725/53; 725/44; 725/45

(57) ABSTRACT

An apparatus for and method of searching multimedia contents on a television is provided. The apparatus includes a content searching unit, which searches for multimedia content files from all media connected to the television; a classifying unit, which classifies the multimedia content files into types; a content database, which stores the multimedia content files by types.

This application claims the priority of Korean Patent Application No. 2003-6536, filed on Feb. 3, 2003, in the Korean Intellectual Property Office, the disclosure of which is incorporated herein in its entirety by reference.

### BACKGROUND OF THE INVENTION

1. Field of the Invention

The present invention relates to an apparatus for and method of searching contents, and more particularly, to an apparatus for and method of searching multimedia contents in a television.

2. Description of the Related Art

The advancement of broadcasting technologies has led to the development of an electronic program guide (EPG) that provides additional information about scheduled programs, such as time-scheduling information and summary of the programs. A broadcasting receiver can receive EPG data to help television users subscribe to or select particular channels.

Recently, the television as a broadcasting receiver also includes a function of reproducing various multimedia contents on its screen in addition to an original function of receiving and displaying broadcast contents. As such, television users have the television to make use of the various multimedia contents, e.g., conveniently enjoying movies, music, games, ads, or photo albums.

Although the television has included from the introduction of the EPG a function of searching and utilizing various additional information of broadcast contents, the television does not yet include a function of searching and managing information of various multimedia contents other than the broadcast contents.

### SUMMARY OF THE INVENTION

The present invention provides an apparatus for and method of searching multimedia contents on a television, which allows a viewer to easily search and manage various multimedia contents on the television.

According to an aspect of the present invention, there is provided an apparatus for searching multimedia contents on a television, the apparatus comprising, a content searching unit, which searches for multimedia content files from all media connected to the television; a classifying unit, which classifies the multimedia content files into types; a content database, which stores the multimedia content files by types.

It is preferable that the content searching unit checks an extension of a file to determine whether the file is a multimedia content file or not.

It is preferable that the classifying unit uses an extension of the file to distinguish whether the file is a moving picture file, a photo or picture file, a music file, or a flash file.

It is preferable that the content database classifies the multimedia content files into types and stores the multimedia contents files along with additional information of the files.

It is preferable that the additional information includes a file name, a file length, a recording date of the file, and the title of the file's multimedia content.

According to another aspect of the present invention, there is provided a television having a function of searching multimedia contents, the television comprising, a storing unit, which stores various contents; a searching unit, which searches for multimedia contents from among the various contents in the storing unit and stores in a database by types of the multimedia contents; a first decoder, which links a multimedia content file selected by a user to a predetermined execution program for decoding; a broadcast stream receiving unit, which receives a broadcast stream data; a second decoder, which demultiplexes and decodes the broadcast stream data from the broadcast stream receiving unit; and an interactive interfacing unit.

It is preferable that the storing unit is a hard disc drive (HDD) or a memory stick.

It is preferable that the searching unit includes a content searching unit, which searches for multimedia content files from all of the media connected to the television; a classifying unit, which classifies the multimedia content files into types; a content database, which stores the multimedia content files by types.

It is preferable that the content searching unit checks extensions of files to determine whether the files are multimedia content files or not.

It is preferable that the classifying unit classifies the multimedia content files into pictures or photograph files, moving picture files, music files, or flash files by using extensions of the files.

It is preferable that the database stores the multimedia content files by types, together with additional information of the files.

It is preferable that the additional information includes a file name, a file length, a recording date, and a title of the file's multimedia content.

According to still another aspect of the present invention, there is provided a method of searching multimedia content on a television, the method comprising, searching for multimedia content files from among all media connected to the television; classifying the multimedia content files by types; and storing the multimedia content files in a database by types.

It is preferable that the searching for multimedia content files is performed by using extensions of the files to check if they are multimedia content files.

It is preferable that the classifying of the multimedia content files by types is performed by using extensions of the files.

It is preferable that the storing of the files in the database by types is performed by classifying the multimedia content files into types, and storing the files together with file names, content types, recording dates and titles of the multimedia contents, respectively.

According to yet another aspect of the invention, there is provided a method of searching and executing multimedia content files on a television, the method comprising searching for multimedia content files from among files stored in all of the media connected with the television when a command is input by a user, classifying the multimedia content files by types, and displaying information of the classified results; linking a file selected by the user from among the information of the classified results to a predetermined execution program; and executing and displaying the file by the predetermined execution program.

It is preferable that the classifying of the multimedia content files by types is performed by classifying the files into moving picture files, audio files, flash files, or picture/photograph files.

It is preferable that the classifying of the files is performed by using extensions of the files.

### BRIEF DESCRIPTION OF THE DRAWINGS

The above and other aspects and advantages of the present invention will become more apparent by describing in detail a preferred embodiment thereof with reference to the attached drawings in which:

FIG. 1 is a schematic block diagram of an apparatus for searching multimedia contents in a television according to the present invention;

FIG. 2 is a schematic block diagram of a television having the apparatus for searching multimedia contents, according to the present invention;

FIG. 3 is a flowchart of a method for searching multimedia contents on television, according to the present invention;

FIG. 4 is a flowchart of an operating method of a television employing a function of searching multimedia contents, according to the present invention.

### DETAILED DESCRIPTION OF THE INVENTION

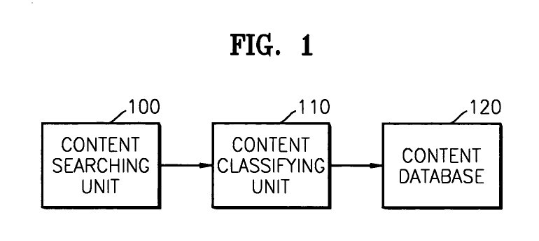

FIG. 1 is a schematic diagram of an apparatus for searching multimedia contents on a television, according to the present invention. The apparatus includes a content searching unit 100, a content classifying unit 110, and a content database 120.

The content searching unit 100 searches for the multimedia content files from all the media connected to the television.

The content classifying unit 110 classifies into types, the multimedia content files searched from the content searching unit 100. The multimedia content files may be classified into still pictures or photograph files, moving picture files, audio files, and flash files. The file classification can be performed using the compression method of the multimedia contents files. For example, joint photographic experts group (JPEG) or graphic interchange format (GIF) files are categorized as still pictures or photograph files, MPEG files are categorized as moving picture files, MP3 files are categorized as audio files, and Seattle Filmworks (SFW) files are categorized as flash files.

The content database 120 stores the multimedia content files based on the file classification.

The apparatus for searching multimedia contents in FIG. 1 is operated by a user via an interactive interface provided by the television. The user can use the interactive interface to search multimedia contents. The user performs the function of searching multimedia contents in the user interactive interface mode, to see and obtain information of the categorized multimedia contents, and then to easily select and display the selected contents.

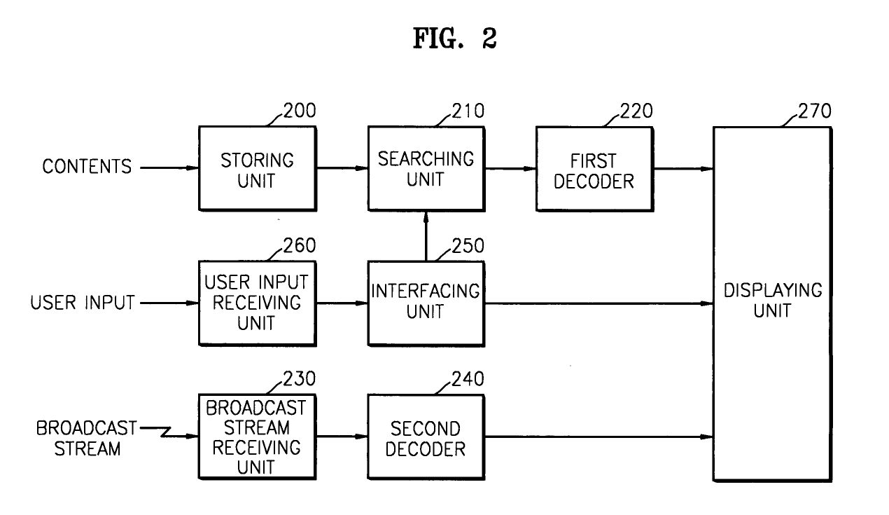

FIG. 2 is a schematic block diagram of a television employing an apparatus for searching multimedia contents in a television. In FIG. 2, the television includes a storing unit 200, a searching unit 210, a first decoder 220, a broadcast stream receiving unit 230, a second decoder 240, an interfacing unit 250, a user input receiving unit 260, and a display unit 270.

The storing unit 200 is a storage media like a hard-disc drive (HDD) or a memory stick, which stores various contents such as movies, photographs, music, games, flash files, etc.

The searching unit 210 searches for the multimedia contents stored in the storing unit 200 and classifies the multimedia contents into types in a database. The searching unit 210 has the same structure and function as the apparatus for searching multimedia contents of FIG. 1.

The first decoder 220 decodes the multimedia contents categorized in the searching unit 210 and selected by a user, by linking corresponding execution programs. In other words, the first decoder 220 decodes the multimedia contents selected in the searching unit 210 in corresponding formats to which the multimedia contents belong among moving pictures, audios, pictures, flash files, etc.

The broadcast stream receiving unit 230 receives electronic program guide (EPG) data and broadcast data in real time via an antenna or a cable.

The second decoder 240 de-multiplexes and decodes the broadcast stream.

The interfacing unit 250 is provided for an interaction activity with a user and represented as an interface screen on the display unit 270. When the interfacing unit 250 receives a request from the user via the user input receiving unit 260 to search multimedia contents, the interfacing unit 250 accesses and display corresponding multimedia contents categorized by types and stored in the database.

The user input receiving unit 260 receives a user command by input devices in the television or by a remote control device.

The display unit 270 displays the multimedia contents and broadcast signal, and also displays the interface screen.

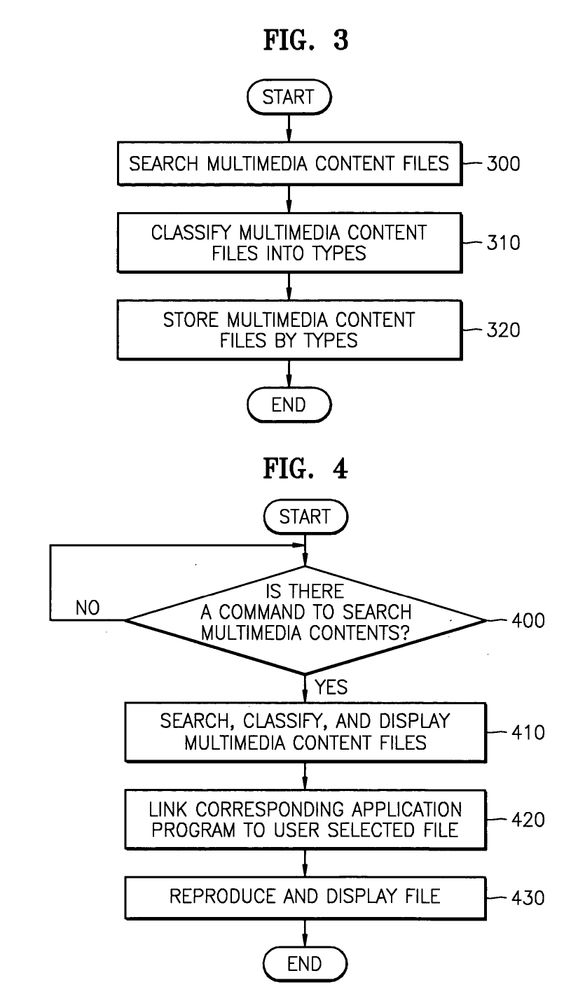

FIG. 3 is a flowchart of an operating method of searching multimedia contents on a television.

First, multimedia content files stored in all the storage media connected to the television are searched for in step 300. Whether a file is related to multimedia contents is determined by checking an extension of the file. Some existing extension formats related to multimedia contents are stored in advance, and the extension of a currently searched files is compared with each of the existing extension formats to determine whether it is a multimedia content file or not.

By using the extension of the searched file, the type of the file is also classified in step 310. For example, if the extension of a file corresponds to a moving picture expert group (MPEG) format, the file is classified as a moving picture file, if the extension of a file is JPEG, GIF, etc., the file is classified as a picture of photograph file, and if the extension of a file is MP3, the file is classified as an audio file. It is understood that a variety of other forms of extensions related to multimedia content not mentioned herein may exist.

Multimedia contents classified under the same category are stored in a database in step 320. When a file is stored in the database, the type, title, length, and recording date of the file are also stored.

The apparatus for searching multimedia content in a television in FIG. 1 is operated by a user via an interactive interface in the television. The user can instruct the television to search multimedia content and obtain the search results. More specific, in an interface mode of the television, the user can place a command to search multimedia content, and can view the searched and categorized multimedia content on a display unit. Along with the multimedia content viewed by the user, titles, lengths, recording dates of the content, etc., are also displayed. Accordingly, the user can easily select and reproduce a desirable content from among the multimedia content.

FIG. 4 is a flowchart of an operating method of a television employing a method of searching multimedia content on the television, according to the present invention.

First, when a command to search multimedia content is input by a user in step 400, multimedia content files from all of the media connected to the television are searched, classified into types, and displayed on the television in step 410. When the user selects a particular file from among the displayed files, the selected file is linked to a corresponding application program to execute the file in step 420. Like this, the selected file is reproduced and displayed in step 430.

According to the present invention, the apparatus for searching multimedia content on a television is highly efficient in searching and reproducing desirable multimedia content files.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. An apparatus for searching multimedia content on a television, the apparatus comprising:
a content searching unit, which searches for multimedia content files from all media connected to the television;
a classifying unit, which classifies the multimedia content files into types;
a content database, which stores the multimedia content files by types.

2. The apparatus of claim 1, wherein the content searching unit checks an extension of a file to determine whether or not the file is a multimedia content file or not.

3. The apparatus of claim 1, wherein the classifying unit uses an extension of a file to determine whether the file is one of a moving picture file, a photo, a picture file, a music file, and a flash file.

4. The apparatus of claim 1, wherein the content database classifies the multimedia content files into types and stores the multimedia contents files along with additional information related to the multimedia content files.

5. The apparatus of claim 4, wherein the additional information comprises a file name, a file length, a recording date of the file, and the title of the file's multimedia content.

6. A television having a function of searching multimedia content, the television comprising:
a storing unit, which stores various content;
a searching unit, which searches for multimedia content from among the various content in the storing unit and stores the multimedia content in a database according to types of the multimedia content;
a first decoder, which links a multimedia content file selected by a user to a predetermined execution program for decoding;
a broadcast stream receiving unit, which receives broadcast stream data;
a second decoder, which de-multiplexes and decodes the broadcast stream data from the broadcast stream receiving unit; and
an interactive interfacing unit.

7. The television of claim 6, wherein the storing unit is one of a hard disc drive (HDD) and a memory stick.

8. The television of claim 6, wherein the searching unit comprises:
a content searching unit, which searches for multimedia content files from all of media connected to the television;
a classifying unit, which classifies the multimedia content files into types;
a content database, which stores the multimedia content files by types.

9. The television of claim 8, wherein the content searching unit checks extensions of files to determine whether or not files are the multimedia content files.

10. The television of claim 8, wherein the classifying unit classifies the multimedia content files into one of pictures, photograph files, moving picture files, music files, and flash files by using extensions of the multimedia content files.

11. The television of claim 8, wherein the database stores the multimedia content files by types, together with additional information of the multimedia content files.

12. The television of claim 11, wherein the additional information comprises a file name, a file length, a recording date, and a title of the multimedia content files.

13. A method of searching multimedia contents on a television, the method comprising:
searching for multimedia content files from among media connected to the television;
classifying the multimedia content files by types; and
storing the multimedia content files in a database by types.

14. The method of claim 13, wherein the searching for multimedia content files is performed by using extensions of the files to check if the files are multimedia content files.

15. The method of claim 13, wherein the classifying of the multimedia content files by types is performed by using extensions of the multimedia content files.

16. The method of claim 13, wherein the storing of the multimedia content files in the database by types is performed by classifying the multimedia content files into types, and storing the multimedia content files together with file names, content types, recording dates and titles of the multimedia contents, respectively.

17. The method of claim 13, wherein all media connected to the television is searched for multimedia content files.

18. A method of searching and executing multimedia content files on a television, the method comprising:
searching for multimedia content files from among files stored in media connected with the television when a command is input by a user, classifying the multimedia content files by types, and displaying information related to the classified results;
linking a file selected by the user based on the information related to the classified results, to a predetermined execution program; and
executing and displaying the file by the predetermined execution program.

19. The method of claim 18, wherein the classifying of the multimedia content files by types is performed by classifying the multimedia content files into one of moving picture files, audio files, flash files, and picture/photograph files.

20. The method of claim 19, wherein the classifying of the multimedia content files is performed by using extensions of the multimedia content files.
